(19) United States
(12) Patent Application Publication
(10) Pub. No.: US 2008/0143758 A1
(43) Pub. Date: Jun. 19, 2008

(54) METHOD OF DRIVING PLASMA DISPLAY PANEL AND PLASMA DISPLAY APPARATUS DRIVEN BY THE METHOD

(75) Inventors: Jae-Kwang Lim, Suwon-si (KR); Jung-Pil Park, Suwon-si (KR); Byung-Tae Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/924,951

(22) Filed: Oct. 26, 2007

(30) Foreign Application Priority Data
Dec. 13, 2006 (KR) 2006-127201

(51) Int. Cl. G09G 5/10

(52) U.S. Cl. 345/691; 345/63

(57) ABSTRACT

A method of driving a plasma display panel by reducing the types of voltages applied to the plasma display panel and a plasma display panel driven by the method include. driving the plasma display panel in which discharge cells are formed on regions where address electrodes cross sustain electrodes in which X electrodes and Y electrodes are disposed in parallel, wherein a unit frame is a display period including a plurality of subfields according to grey scale weighted values in order to display a time division grey scale, and each of the subfields includes a reset period, an address period, and a sustain discharge period, during the reset period, a first voltage and a first ramp-down pulse that falls from a second voltage that is lower than the first voltage to a third voltage that is lower than the second voltage is applied to the Y electrodes, and a second ramp-down pulse that falls from a fourth voltage to a fifth voltage that is lower than the fourth voltage is applied to the X electrodes when the first voltage is applied to the X electrodes.

### CROSS-REFERENCE TO RELATED APPLICATION

This application claims the benefit of Korean Patent Application No. 2006-127201, filed on Dec. 13, 2006 in the Korean Intellectual Property Office, the disclosure of which is incorporated herein by reference.

### BACKGROUND OF THE INVENTION

1. Field of the Invention

An aspect of the present invention relates to a method of driving a plasma display panel by reducing the number of types of voltages and the plasma display apparatus driven by the method.

2. Description of the Related Art

Plasma display panels display a predetermined image by exciting a phosphor material using ultraviolet rays generated from a gas discharge. Due to the high resolution with a large screen image, the plasma display panels are expected to be thin film display devices for the next generation.

Plasma display panels can be classified into direct current (DC) type, alternating current (AC) type, and hybrid current type according to the structure and method of driving the plasma display panels. In particular, the AC type and DC type plasma display panels can be divided into surface discharge type and facing discharge type, respectively. Recently, the AC type plasma display panels have become popular in the market. A conventional three-electrode surface discharge type plasma display panel has a multi-layered plate. The three-electrode surface discharge type plasma display panel is thin and light weight and can provide a wide image.

The plasma display panel described above includes a plurality of display cells formed on regions where sustain electrodes and address electrodes cross. Each of the display cells has three discharge cells of red, green, and blue colors. Image grey scales can be displayed by controlling discharge states of the discharge cells.

In order to display 256 grey scales of a plasma display panel, a unit frame that is applied to the plasma display panel is divided into eight subfields having different numbers of light emission. That is, in order to display an image using 256 grey scales, a unit frame period (16.67 ms) corresponding to 1.6 seconds is divided into eight subfields. Each of the subfields includes a reset period, an address period, and a sustain discharge period in order to drive the plasma display panel.

FIG. 1 is a timing diagram of a subfield SF for explaining a conventional method of driving a plasma display panel. Referring to FIG. 1, the subfield SF includes a reset period PR in which the discharge cells are initialized, an address period PA in which the discharge cells are selected, and a sustain discharge period PS in which the selected discharge cells are discharged.

During the reset period PR of the subfield SF, a ramp-up pulse that slowly rises from a sustain discharge voltage Vs to a ramp-up maximum voltage Vs+Vset is applied to Y electrodes Y of the plasma display panel. Then, a ramp-down pulse that falls from the sustain discharge voltage Vs to a ground voltage Vg is applied to the Y electrodes Y of the plasma display panel. The ground voltage Vg is applied to the X electrodes X of the plasma display panel when the ramp-up pulse is applied to the Y electrodes Y, and a biased voltage Ve is applied to X electrodes X of the plasma display panel when the ramp-down pulse is applied to the Y electrodes Y of the plasma display panel during the reset period PR. The ground voltage Vg is applied to the address electrodes A during the reset period PR. Thus, a reset discharge is generated.

During the address period PA of the subfield SF, discharge cells, in which a sustain discharge is to be generated, are selected by sequentially applying a scan pulse to the Y electrodes Y of the plasma display panel and by applying a data pulse synchronized with the scan pulse Va to the address electrodes A of the plasma display panel that are formed in the corresponding discharge cells that are to be displayed.

During a subsequent sustain discharge period PS of the subfield SF, a sustain pulse Vs is applied to the X electrodes X and the Y electrodes Y of the plasma display panel so that the sustain discharge can be generated in the selected discharge cells. Thus, an image is displayed.

In the prior art, a plasma display panel is driven by a positive sustain driving method in which a positive polarity voltage sustain pulse is applied during the sustain discharge period. However, in this case, a problem of damaging the phosphor material due to direct collisions of positive ions occurs. Therefore, a negative sustain driving method in which a negative polarity voltage sustain pulse is applied to electrodes has recently been attempted. However, in the negative sustain driving method, there are a wide range of voltages that can be applied to the Y electrodes Y such as from the ramp-up maximum voltage Vs+Vset to a sustain discharge voltage −Vs, and the types of voltages that can be applied to the Y electrodes Y increases. The range and type of voltages that can be applied to the X electrodes X also increases. As a result, the driving of a plasma display panel is difficult.

### SUMMARY OF THE INVENTION

An aspect of the present invention provides a method of driving a plasma display panel that increases the lifetime of the plasma display panel by preventing damage of a phosphor material and allows easy driving of the plasma display panel by reducing the types of voltages that can be applied to the plasma display panel and a plasma display apparatus driven by the method.

According to an aspect of the present invention, there is provided a method of driving a plasma display panel in which discharge cells are formed on regions where address electrodes cross sustain electrode pairs in which X electrodes and Y electrodes are disposed in parallel, wherein a unit frame is a display period comprising of a plurality of subfields according to grey scale weighted values to display a time division grey scale, and each of the subfields includes a reset period, an address period, and a sustain discharge period, during the reset period, a first voltage and a first ramp-down pulse that falls from a second voltage that is lower than the first voltage to a third voltage which is lower than the second voltage are applied to the Y electrodes, and a second ramp-down pulse that falls from a fourth voltage to a fifth voltage that is lower than the fourth voltage is applied to the X electrodes when the first voltage is applied to the X electrodes.

According to an aspect of the present invention, during the sustain discharge period, a seventh voltage that is a negative polarity voltage with respect to a sixth voltage may be alternately applied to the X electrodes and the Y electrodes. The seventh voltage may be a negative polarity voltage and a negative sustain driving method may be performed during the sustain discharge period.

According to another aspect of the present invention, the third voltage may be identical to the seventh voltage, and the fifth voltage may be identical to the seventh voltage.

According to another aspect of the present invention, during the reset period, an eighth voltage may be applied to the X electrodes when the first ramp-down pulse is applied to the Y electrodes.

According to another aspect of the present invention, during the address period, a scan pulse may be applied to the Y electrodes, the eighth voltage may be applied to the X electrodes, and a data pulse may be applied to the address electrodes simultaneously when the scan pulse is applied to the Y electrodes.

According to an aspect of the present invention, there is provided a plasma display apparatus including: a plasma display panel having a first substrate and a second substrate that are separated from each other and face each other; X electrodes and Y electrodes extending across discharge cells that are discharge spaces disposed between the first and second substrates; and address electrodes extending across the discharge cells perpendicularly crossing the X electrodes and the Y electrodes; and a panel driver that applies driving signals to the X electrodes, the Y electrodes, and the address electrodes, wherein the driving signal includes a unit frame having a plurality of subfields for displaying a time division grey scale, and each of the subfields includes a reset period, an address period, and a sustain discharge period, the panel driver includes a Y driving unit that applies a first voltage and a first ramp-down pulse that falls from a second voltage which is lower than the first voltage to a third voltage which is lower than the second voltage to the Y electrodes, and an X driving unit that applies a second ramp-down pulse that falls from a fourth voltage to a fifth voltage which is lower than the fourth voltage when the first voltage is applied to the Y electrodes during the reset period.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a timing diagram for explaining a conventional method of driving a plasma display panel;

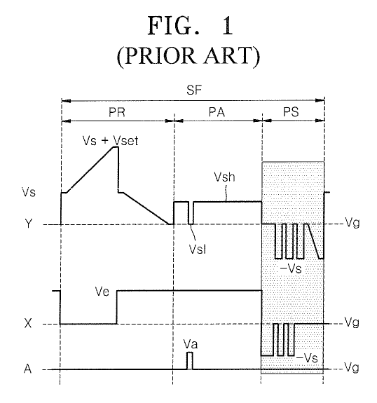

FIG. 2 is a perspective view of a structure of a plasma display panel according to an embodiment of the present invention;

FIG. 3 is a block diagram for explaining a plasma display apparatus according to an embodiment of the present invention;

FIG. 4 is a timing diagram illustrating a method of driving a plasma display panel of FIG. 2, according to an embodiment of the present invention, in which a unit frame is divided into a plurality of subfields; and

FIG. 5 is a timing diagram for explaining a method of driving a plasma display panel of FIG. 2, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

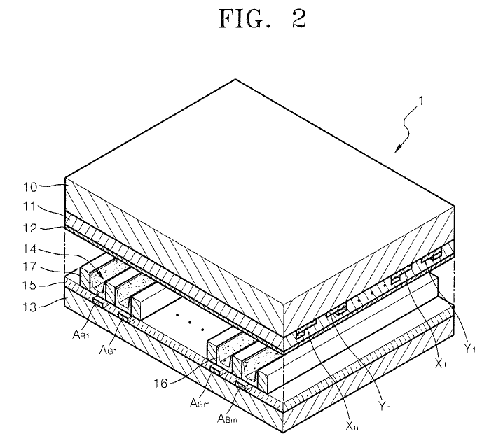

FIG. 2 is a perspective view illustrating a structure of a three-electrode surface discharge type plasma display panel 1 according to an embodiment of the present invention. Referring to FIG. 2, address electrode lines A_{R1} through A_{Bm}, upper and lower dielectric layers 11 and 15, Y electrode lines Y₁ through Yₙ, X electrode lines X₁ through Xₙ, a phosphor layer 16, barrier ribs 17, and an MgO layer 12 as a passivation layer are formed between front and rear glass substrates 10 and 13 of the three-electrode surface discharge type plasma display panel 1.

The address electrode lines A_{R1} through A_{Bm} are formed in a predetermined pattern on a front surface of the rear glass substrate 13. The lower dielectric layer 15 is coated on the entire front surfaces of the address electrode lines A_{R1} through A_{Bm}. The barrier ribs 17 are formed in parallel to the address electrode lines A_{R1} through A_{Bm} on the front surface of the lower dielectric layer 15. The barrier ribs 17 define a discharge space of discharge cells 14 and prevent optical cross-talk between the discharge cells 14. The phosphor layer 16 is formed on inner surfaces of a space defined by the barrier ribs 17 and the lower dielectric layer 15 that is formed on the rear glass substrate 13.

The X electrode lines X₁ through Xₙ and the Y electrode lines Y₁ through Yₙ are formed in a predetermined pattern on a rear surface of the front glass substrate 10 perpendicularly crossing the address electrode lines A_{R1} through A_{Bm}. Each of the crossing points between the X electrode lines X₁ through Xₙ and the Y electrode lines Y₁ through Yₙ with the address electrode lines A_{R1} through A_{Bm} defines corresponding discharge cells 14. The X electrode lines X₁ through Xₙ and the Y electrode lines Y₁ through Yₙ respectively are formed by combining a transparent electrode line formed of a transparent conductive material such as indium tin oxide (ITO) and a metal electrode line to increase conductivity. The X electrode lines X₁ through Xₙ are sustain electrodes in each of the discharge cells 14, the Y electrode lines Y₁ through Yₙ are scan electrodes in each of the discharge cells 14, and the address electrode lines A_{R1} through A_{Bm} are address electrodes in each of the discharge cells 14.

In this embodiment of the present invention, a three-electrode surface discharge type plasma display panel 1 is described, but the embodiments of the present invention are not limited thereto. That is, the embodiments of the present invention can be applied to various types of plasma display panels including a ring discharge type display panel in which electrodes formed in barrier ribs surround a discharge space or a two-electrode type plasma display panel that includes scan electrodes and address electrodes.

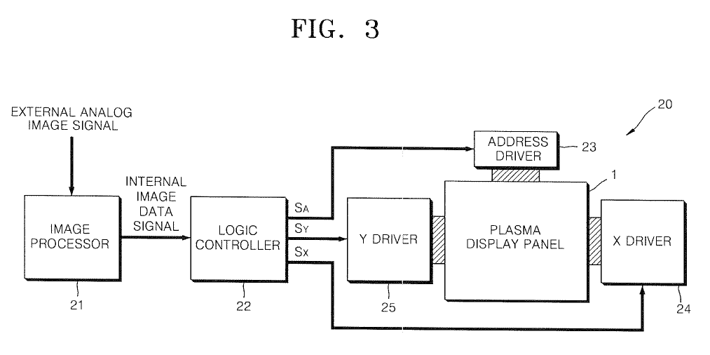

FIG. 3 is a block diagram for explaining a panel driver 20 of a plasma display apparatus of the three-electrode surface discharge type plasma display panel 1 of FIG. 2, according to an embodiment of the present invention.

Referring to FIG. 3, the panel driver 20 of the plasma display apparatus of the three-electrode surface discharge type plasma display panel 1 includes an image processing unit or image processor 21, a logic control unit or logic controller 22, an address driving unit or address driver 23, an X driving unit or X driver 24, and a Y driving unit or Y driver 25. The image processing unit 21 of the panel driver 20 generates internal image signals by transforming external analog image signals into digital signals. The internal image signals respectively can be eight bits of red R, green G, and blue B color image data, clock signals, or vertical and horizontal synchronizing signals. The logic control unit 22 of the panel driver 20 generates X, Y, and A driving control signals S_{A}, S_{Y}, and S_{X} in response to the internal image signals received from the image processing unit 21.

In the embodiment of the present embodiment, the address driving unit 23, the X driving unit 24, and the Y driving unit 25 of the panel driver 20, respectively generate driving signals in response to the X, Y, and A driving control signals S_{A}, S_{Y}, and S_{X} received from the logic control unit 22 and respectively apply the generated driving signals to the X electrode lines X₁ through Xₙ, Y electrode lines Y₁ through Yₙ, and address electrode lines A_{R1} through A_{Bm}. That is, the address driving unit 23 generates a data pulse in response to the driving control signal S_{A} received from the logic control unit 22 and applies the data pulse to the address electrode lines A_{R1} through A_{Bm}.

The Y driving unit 25 processes the Y driving control signal S_{Y} received from the logic control unit 22 and then applies the Y driving control signal S_{Y} to the Y electrode lines Y₁ through Yₙ. More specifically, the Y driving unit 25 applies a sustain discharge voltage Vs to the Y electrode lines Y₁ through Yₙ in response to the Y driving control signal S_{Y} received from the logic control unit 22 during a reset period PR, and applies a first ramp-down pulse that falls from a ground voltage Vg to a negative polarity sustain discharge voltage −Vs to the Y electrode lines Y₁ through Yₙ during the reset period PR.

The X driving unit 24 processes the X driving control signal S_{X} received from the logic control unit 22 and then applies the X driving control signal S_{X} to the X electrode lines X₁ through Xₙ. More specifically, during the reset period PR, the X driving unit 24 applies a second ramp-down pulse that falls from the ground voltage Vg to the negative polarity sustain discharge voltage −Vs to the X electrode lines X₁ through Xₙ in response to the X driving control signal S_{X} when the sustain discharge voltage Vs is applied to the Y electrode lines Y₁ through Yₙ.

Also, during a sustain discharge period PS, the X driving unit 24 and the Y driving unit 25 respectively apply the negative polarity sustain discharge voltage −Vs to the X electrode lines X₁ through Xₙ and the Y electrode lines Y₁ through Yₙ, and thus a negative sustain driving method is performed.

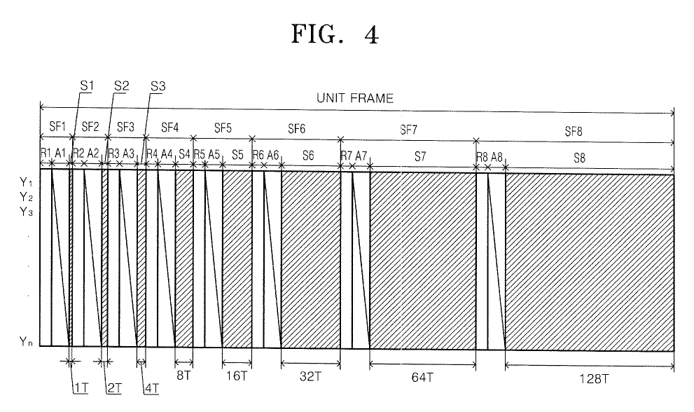

The panel driver 20 of the three-electrode surface discharge type plasma display panel 1 according to an embodiment of the present embodiment uses the driving method depicted in FIG. 4. FIG. 4 is a timing diagram showing the method of driving the three-electrode surface discharge plasma display panel 1 of FIG. 2 driven by dividing a unit frame FR into a plurality of subfields SF1 through SF8, according to an embodiment of the present invention.

Referring to FIG. 4, in order to display a time division grey scale, the unit frame FR is divided into eight subfields SF1 through SF8. Each of the subfields SF1 through SF8 includes reset periods R1 through R8, address periods A1 through A8, and sustain discharge periods S1 through S8.

Brightness of the three-electrode surface discharge plasma display panel 1 is proportional to the length of the sustain discharge periods S1 through S8 during the unit frame FR. The length of the sustain discharge periods S1 through S8 during the unit frame FR is 255 T, where T is a time unit. In the shown embodiment, each time corresponding to 2ⁿ is respectively set during a sustain discharge period Sn of the nth subfield SFn. Accordingly, if the subfields that are to be displayed are appropriately selected from the eight subfields SF1 through SF8, 256 grey scales including the 0 (zero) grey scale that is not displayed in any of the eight subfields SF1 through SF8 can be performed altogether.

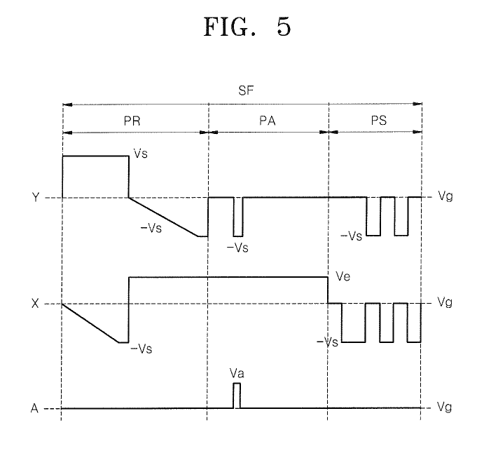

FIG. 5 is a timing diagram of driving signals outputted from the X driving unit 24, the Y driving unit 25, and the address driving unit 23 of the panel driver 20 of the plasma display apparatus of FIG. 3, according to an embodiment of the present invention. A unit frame for driving the plasma display panel 1 is divided into a plurality of subfields. Each of the subfields is divided into a reset period PR, an address period PA, and a sustain discharge period PS.

During the reset period PR, a sustain discharge voltage Vs applied to the Y electrode lines Y₁ through Yₙ is maintained constant for a period of time, and then, a first ramp-down pulse that slowly falls from a ground voltage Vg to a negative polarity sustain discharge voltage −Vs is applied to the Y electrode lines Y₁ through Yₙ. Also, a second ramp-down pulse that slowly falls from the ground voltage Vg to the negative polarity sustain discharge voltage −Vs is applied to the X electrode lines X₁ through Xₙ when the constant sustain discharge voltage Vs is applied to the Y electrode lines Y₁ through Yₙ during the reset period PR. Also, a biased voltage Ve is applied to the X electrode lines X₁ through Xₙ when the first ramp-down pulse is applied to the Y electrode lines Y₁ through Yₙ.

During the reset period PR, the ground voltage Vg is applied to address electrodes A. Thus, discharge cells 14 of the three-electrode surface discharge type plasma display panel 1 can be initialized. In the present embodiment, a negative sustain driving method is performed during the sustain discharge period PS, which will be described later. Also, the negative sustain driving method is advantageous for erasing wall charges by using a priming effect generated during the sustain discharge period PS. That is, a reset discharge can be smoothly performed during the reset period PR.

After the reset discharge, during the address period PA in which discharge cells 14 where sustain discharge is to be generated are selected, address discharge is performed by sequentially applying a scan pulse to the Y electrode lines Y₁ through Yₙ and by applying a data pulse synchronized with the scan pulse to the address electrode lines A_{R1} through A_{Bm}. The scan pulse that is applied to the Y electrode lines Y₁ through Yₙ is the negative polarity sustain discharge voltage −Vs, and the data pulse that is applied to the address electrode lines A_{R1} through A_{Bm} is a positive polarity address voltage Va having an opposite polarity to the scan pulse having the −Vs voltage. The biased voltage Ve is applied to the X electrode lines X₁ through Xₙ during the address period PA.

After the address discharge, during the sustain discharge period PS, a sustain pulse is alternately applied to the X electrode lines X₁ through Xₙ and the Y electrode lines Y₁ through Yₙ. The sustain pulse is a pulse that alternately has a voltage from the ground voltage Vg to the negative polarity sustain discharge voltage −Vs, and thus the negative sustain driving is performed by applying the sustain pulse. Accordingly, when the sustain discharge is performed, brightness is displayed according to a grey scale weighted value allocated to each of the subfields.

According to the driving method described above, the Y driving unit 25 includes a sustain discharge voltage source and a negative polarity sustain discharge voltage source, the X driving unit 24 includes a negative polarity sustain discharge voltage source and a biased voltage source. That is, the plasma display panel 1 can be driven by a reduced number of voltages. Also, the plasma display panel 1 can be driven by applying a relatively low voltage such as from the sustain discharge voltage Vs to the negative polarity sustain discharge voltage −Vs to the Y electrode lines Y₁ through Yₙ, and thus, noise generation can be reduced. As such, damage to a phosphor material due to the collision of electrons can be prevented since the sustain discharge is performed by applying the sustain discharge voltage Vs in a range from the biased voltage Ve to the negative polarity sustain discharge voltage −Vs to the X electrode lines X₁ through Xₙ.

As described above, according to the method of driving a plasma display panel, driving is easy since the types of voltages is reduced, and in a reset period, the use of a relatively low driving voltage is possible, and thus, the number of parts of the apparatus can be reduced. Also, a low voltage can drive the plasma display panel, thus reducing noise generation. Accordingly, damage to a phosphor material can be prevented since a negative sustain driving method is performed during the sustain discharge period.

Also, according to the method of driving a plasma display panel, manufacturing productivity of the plasma display apparatus can be increased since the types of voltages required for driving the plasma display apparatus are reduced and the number of parts utilized in the apparatus can also be reduced. Also, according to the method of driving a plasma display panel, a clean image without noise can be displayed, and the lifetime of the apparatus can be extended. Furthermore, image quality can be improved since damage of the phosphor material can be prevented, thereby increasing reliability of the plasma display apparatus.

While not required, it is understood that aspects of the invention can be implemented as software or as firmware encoded on computer readable media, such as an optical disc, magnetic disk, etc., readable by one or more computers and/or processors.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of driving a plasma display panel in which discharge cells are formed on regions where address electrodes cross sustain electrodes X and scan electrodes Y, the X electrodes and the Y electrodes being disposed parallel to each other, and a unit frame comprising a plurality of subfields according to grey scale weighted values to display a time division grey scale, each subfield comprising a reset period, an address period, and a sustain discharge period, the method comprising:
applying to the Y electrodes during the reset period a first voltage and a first ramp-down pulse that falls from a second voltage that is lower than the first voltage to a third voltage which is lower than the second voltage, and
applying to the X electrodes during the reset period a second ramp-down pulse that falls from a fourth voltage to a fifth voltage that is lower than the fourth voltage, when the first voltage is applied to the X electrodes.

2. The method of claim 1, wherein, during the sustain discharge period, a sixth and a seventh voltage that is a negative polarity voltage with respect to the sixth voltage are alternately applied to the X electrodes and the Y electrodes.

3. The method of claim 2, wherein the third voltage is identical to the seventh voltage.

4. The method of claim 2, wherein the fifth voltage is identical to the seventh voltage.

5. The method of claim 2, wherein, during the reset period, an eighth voltage is applied to the X electrodes when the first ramp-down pulse is applied to the Y electrodes.

6. The method of claim 5, wherein, during the address period,
a scan pulse is applied to the Y electrodes,
the eighth voltage is applied to the X electrodes, and
a data pulse is applied to the address electrodes simultaneously with the scan pulse that is applied to the Y electrodes.

7. The method of claim 6, wherein, during the address period, the scan pulse having the second voltage and the third voltage is applied to the Y electrodes.

8. The method of claim 7, wherein the second voltage and the third voltage are respectively identical to the sixth voltage and the seventh voltage alternately applied to the X electrodes and the Y electrodes during a sustain discharge period.

9. The method of claim 1, wherein the first voltage is a sustain discharge voltage Vs, the second and the fourth voltages are ground voltages Vg and the third and the fifth voltages are negative polarity sustain discharge voltages −Vs.

10. The method of claim 2, wherein the sixth voltage is a ground voltage Vg and the seventh voltage is a negative polarity sustain discharge voltage −Vs.

11. The method of claim 5, wherein the eighth voltage is a bias voltage Ve.

12. The method of claim 1, wherein, during the sustain discharge period, a voltage applied to the X electrodes ranges from a biased voltage Ve to a negative polarity sustain discharge voltage −Vs.

13. A plasma display apparatus comprising:
a plasma display panel comprising:
a first substrate and a second substrate that are separated from each other and face each other;
X electrodes and Y electrodes extending across discharge cells that are discharge spaces disposed between the first and second substrates; and
address electrodes extending across the discharge cells perpendicularly crossing the X electrodes and the Y electrodes; and
a panel driver that applies driving signals to the X electrodes, the Y electrodes, and address electrodes,
wherein the driving signal comprises a unit frame comprising a plurality of subfields for displaying a time division grey scale, and each of the subfields comprises a reset period, an address period, and a sustain discharge period,
the panel driver comprises a Y driving unit that applies a first voltage and a first ramp-down pulse that falls from a second voltage that is lower than the first voltage to a third voltage that is lower than the second voltage to the Y electrodes, and an X driving unit that applies a second ramp-down pulse that falls from a fourth voltage to a fifth voltage that is lower than the fourth voltage to the X electrodes when the first voltage is applied to the Y electrodes during the reset period.

14. The plasma display apparatus of claim 13, wherein the X driving unit and the Y driving unit alternately apply a sixth and a seventh voltage that is a negative polarity voltage with respect to the sixth voltage to the X electrodes and the Y electrodes.

15. The plasma display apparatus of claim 14, wherein the third voltage is identical to the seventh voltage.

16. The plasma display apparatus of claim 15, wherein the fifth voltage is identical to the seventh voltage.

17. The plasma display apparatus of claim 13, wherein the first voltage is a sustain discharge voltage Vs, the second and the fourth voltages are ground voltages Vg and the third and the fifth voltages are negative polarity discharge voltages −Vs.

18. A method of driving a plasma display panel including discharge cells formed on regions where A address electrodes cross X sustain electrodes and Y scan electrodes, the X electrodes and the Y electrodes being parallel to each other, and a unit frame comprising a plurality of subfields, and each subfield comprising a reset period, an address period, and a sustain discharge period, the method comprising:
applying and maintaining constant a sustain discharge voltage Vs to the Y electrodes during a first time period, and applying to the Y electrodes a first ramp-down pulse ranging from a ground voltage Vg to a negative polarity sustain discharge voltage −Vs during a second time period;
applying to the X electrodes a second ramp-down pulse ranging from the ground voltage Vg to the negative polarity sustain discharge voltage −Vs during the first time period and applying and maintaining constant a biased voltage Ve to the X electrodes during the second time period; and
applying the ground voltage Vg to the address electrodes during the first and second time periods initializing the discharge cells.

19. A computer readable medium encoded with processing instructions for implementing the method of claim 1 using one or more processors.

20. A computer readable medium encoded with processing instructions for implementing the method of claim 18 using one or more processors.
